(19) United States
(12) Patent Application Publication
(10) Pub. No.: US 2024/0247632 A1
(43) Pub. Date: Jul. 25, 2024

(54) Hydropower Water Source Modification

(71) Applicant: Bob Burkett, Carrollton, TX (US)

(72) Inventor: Bob Burkett, Carrollton, TX (US)

(73) Assignee: Bob Burkett, Carrollton, TX (US)

(21) Appl. No.: 18/415,970

(22) Filed: Jan. 18, 2024

Related U.S. Application Data
(60) Provisional application No. 63/440,375, filed on Jan. 20, 2023.

(51) Int. Cl. F03B 13/06; F03B 3/00; F03B 17/06

(52) U.S. Cl. CPC F03B 13/06; F03B 3/00; F03B 17/06

(57) ABSTRACT

The world is being subjected to droughts that lower the lakes that provide the water for hydropower electricity production. Cities and towns around the dams also consume the water. At a certain point, the water level is too low for the dam to generate power. Hydropower Water Source Modification is a solution to this dilemma. A main piping loop from the output of the water after it passes through the turbine that spins the generator is connected to a high powered water pump at either the base of the dam and/or at the top of the dam. The piping loop is then connected to the intake of the penstock and completes the loop. The power supplied to the water pumps can be from one or more sources.

### CROSS-REFERENCE TO RELATED APPLICATIONS

This application claims the benefit of the filing of U.S. Provisional Patent Application No. 63/440,375 filed on Jan. 20, 2023.

### BACKGROUND OF THE INVENTION

Hydropower is a primary source of fossil fuel free electricity production around the world. However, hydropower is dependent upon rainfall, snowpack and other forms of water generation in order to provide enough water for the water to turn the turbines that spin the generator. In the desert Southwest there is currently a drought in the United States resulting in the draining of the Colorado River. This is proving to be a major problem for the water supply for both communities and states. The lack of water has also affected hydropower electricity production for surrounding communities and states. The drought situation is also occurring around the world. A solution is necessary before both the power and the water run out.

An example is the water level in Lake Powell behind Glen Canyon Dam. As the level of the water declines the generators produce less power as the weight of the water is decreased. The Glen Canyon Dam is very close to reaching minimum power pool (MPP) which is the level at which point the dam can no longer produce electricity. In addition, should the level of water continue to drop it will reach “deadpool level” at which point no water will pass through the dam. This is potentially a dire situation.

### BRIEF SUMMARY OF THE INVENTION

A dam generates electricity by storing water behind the dam. The water is then released into pipes, tubes and/or tunnels that feed the water into the turbine that spins the generator in order to make electricity that is sent to the grid. However, if the water is too low there is not enough pressure to generate maximum output of the generator. At the same time if there is no water the turbines cannot turn.

The solution to this dilemma is to construct a main piping loop from the output of the water after it passes through the turbine that spins the generator and connect a main piping loop to a high powered water pump. This pump would force the water to the top of the dam through the same main piping loop that would either go over the top of the dam or some other circuitous route that would serve the same effect which is to connect the loop to the water input that turns the turbine that spins the generator. When the water goes over the dam and down the other side it would create a siphon effect that would reduce the load necessary on the water pump. Also, a centrifugal and centripetal force would apply. An alternative embodiment would include the main piping loop connected to an underwater and/or underground piping loop that cools and/or heats the water before it is returned to the turbine.

Massive water pumps already exist that can complete this task. These electric pumps could be powered by the power plant generator, the grid, wind farms, solar panels and/or any other alternative power source.

### BRIEF DESCRIPTION OF THE SEVERAL VIEWS OF THE DRAWINGS

FIG. 1 is a view of a dam with the main piping loop as the water passes the turbine output and the water is pumped over the top of the dam with one or more water pumps being powered by the generator.

FIG. 2 is a view of a dam with the main piping loop and the one or more water pumps at the bottom of the dam being powered by the generator, the grid, solar panels, wind turbine and/or any other alternative power source.

FIG. 3 is a view of the one or more water pumps at the top of the dam being powered by the generator, the grid, solar panels, wind turbine and/or any other alternative power source.

FIG. 4 is a view of the water in the main piping loop being cooled through an underwater and/or underground piping loop.

### DETAILED DESCRIPTION OF THE INVENTION

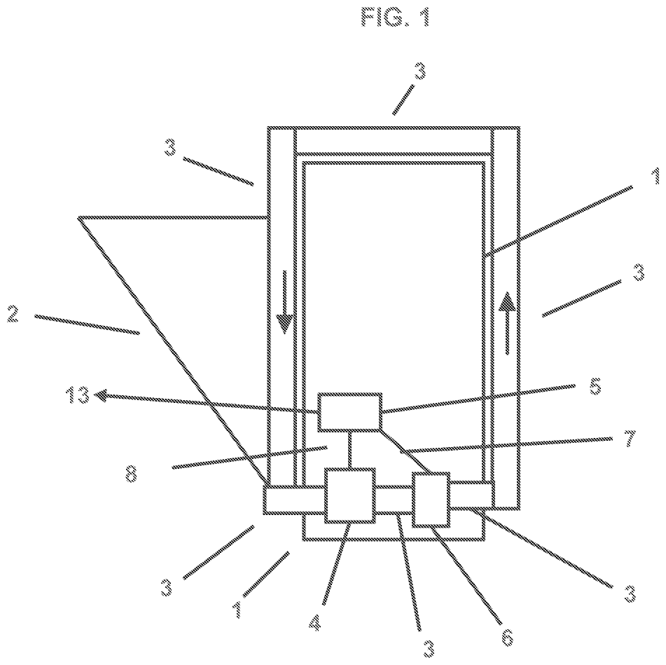

### Embodiment 1 (FIG. 1)

The dam (1) holds back the water (2). The main piping (3) loop connects the water output from the turbine (4) to one or more water pumps (6). The main piping (3) loop connects the one or more water pumps (6) to the water input of the turbine (4).

The turbine (4) is mechanically connected to the generator (5) via an appropriate connector (8). The generator (5) sends power to the one or more water pumps (6) via power connector (7). The surplus power generated by the power plant generator (5) is sent to the grid (13).

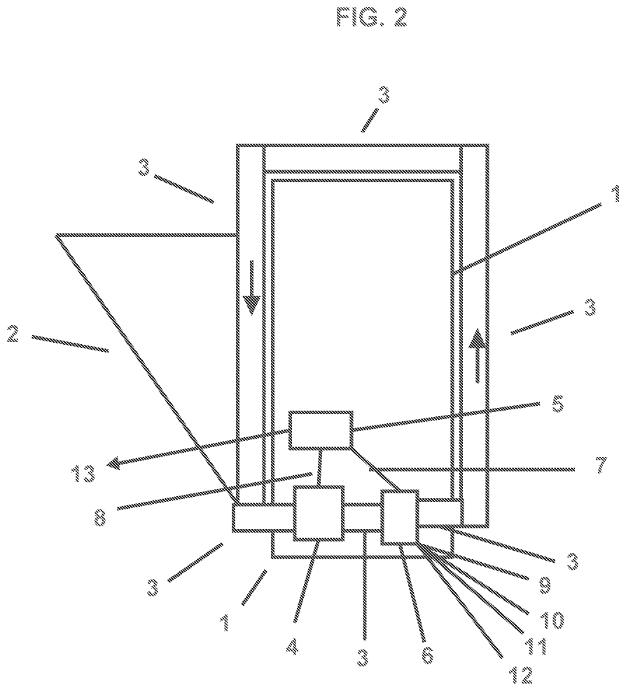

### Embodiment 2 (FIG. 2)

The dam (1) holds back the water (2). The main piping (3) loop connects the water output from the turbine (4) to one or more water pumps (6) located at the bottom of the dam. The piping (3) loop connects the one or more water pumps (6) water output to the water input of the turbine (4).

The turbine (4) is mechanically connected to the generator (5) via an appropriate connector (8). The generator (5) sends power to the one or more water pumps (6) via power connector (7). The one or more water pumps (6) can be powered by the grid (9) and/or solar panels (10) and/or wind turbines (11) and/or any other alternative power source (12). The surplus power generated by the power plant generator (5) is sent to the grid (13).

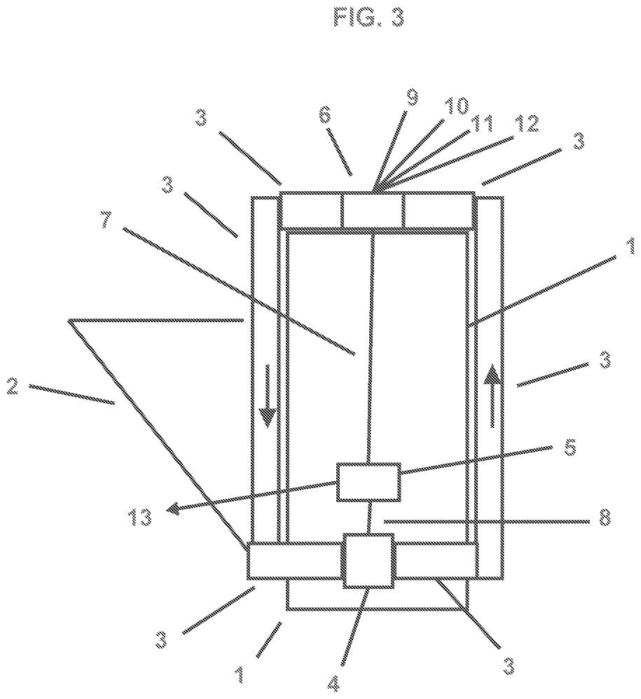

### Embodiment 3 (FIG. 3)

The dam (1) holds back the water (2). The main piping (3) loop connects the water output from the turbine (4) to one or more water pumps (6) located at the top of the dam. The main piping (3) loop connects one or more water pumps (6) water output to the water input of the turbine (4).

The turbine (4) is mechanically connected to the generator (5) via an appropriate connector (8). The generator (5) sends power to the one or more water pumps (6) via power connector (7). The one or more water pumps (6) can also be powered by the grid (9) and/or solar panels (10) and/or wind turbines (11) and/or any other alternative power source (12). The surplus power generated by the power plant generator (5) is sent to the grid (13).

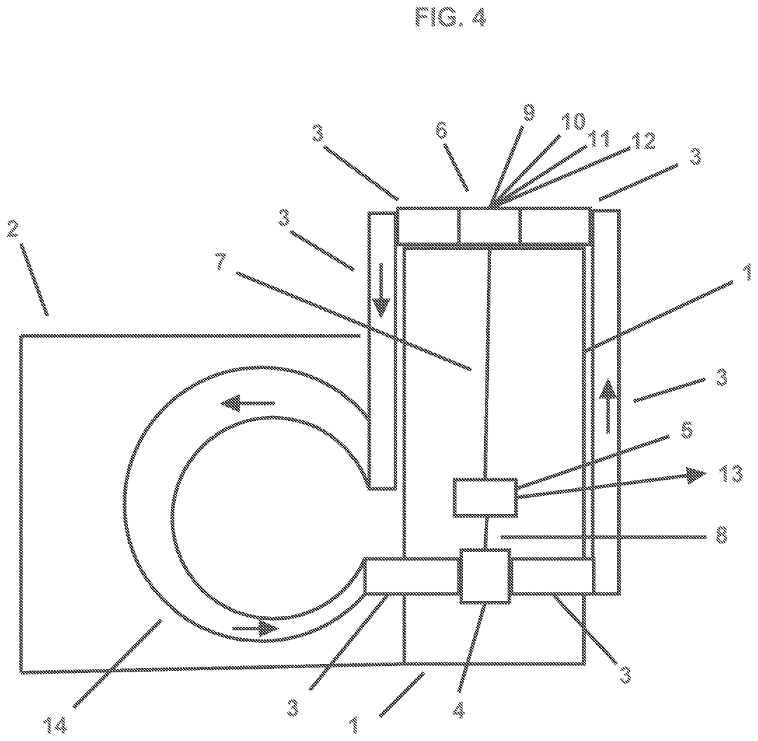

### Embodiment 4 (FIG. 4)

The dam (1) holds back the water (2). The main piping (3) loop connects the water output from the turbine (4) to one or more water pumps (6) located at the top of the dam. The main piping (3) loop connects to an underwater and/or underground piping loop (14) that cools and/or heats the water before it is returned to the turbine (4) via main piping loop (3) and the process begins again.

The turbine (4) is mechanically connected to the generator (5) via an appropriate connector (8). The generator (5) sends power to the one or more water pumps (6) via the power connector (7). The one or more water pumps (6) can also be powered by the grid (9) and/or solar panels (10) and/or wind turbines (11) and/or any other alternative power source (12). The surplus power generated by the power plant generator (5) is sent to the grid (13).

### LIST OF REFERENCE NUMERALS

1. Dam
2. Water
3. Main piping loop
4. Turbine
5. Generator
6. One or more water pumps
7. Power connector
8. Mechanical connector
9. Grid
10. Solar panels
11. Wind turbines
12. Any other alternative power source
13. Power sent to the grid
14. Underwater and/or underground piping loop

1. A system to generate power in a hydropower plant, comprising:
the hydropower plant;
a turbine;
a generator;
one or more water pumps;
a main piping loop; and
whereby the water output from the turbine is pumped by one or more water pumps into a main piping loop that sends the water from the turbine output back to the turbine input that spins a generator that sends power to one or more water pumps and/or the grid.

2. The system according to claim 1 wherein the one or more water pumps are located at the top and/or bottom of the dam.

3. The system according to claim 1 wherein the one or more water pumps are powered by the grid.

4. The system according to claim 1 wherein the one or more water pumps are powered by solar panels.

5. The system according to claim 1 wherein the one or more water pumps are powered by wind turbines.

6. The system according to claim 1 wherein the one or more water pumps are powered by any other alternative power source.

7. A system to generate power in a hydropower plant, comprising:
the hydropower plant;
a turbine;
a generator;
one or more water pumps;
a main piping loop;
an underwater and/or underground piping loop; and
whereby the water output from the turbine is pumped by one/or more water pumps into a main piping loop that sends the water to an underwater and/or underground piping loop and back to the turbine that spins a generator that sends power to one or more water pumps and/or the grid.

8. The system according to claim 7 wherein the one or more water pumps are located at the top and/or bottom of the dam.

9. The system according to claim 7 wherein the one or more water pumps are powered by the grid.

10. The system according to claim 7 wherein the one or more water pumps are powered by solar panels.

11. The system according to claim 7 wherein the one or more water pumps are powered by wind turbines.

12. The system according to claim 7 wherein one or more water pumps are powered by any other alternative power source.
